(19) United States
(12) Patent Application Publication
(10) Pub. No.: US 2006/0031408 A1
(43) Pub. Date: Feb. 9, 2006

(54) Push to activate and connect client/server applications

(75) Inventor: Jyh-Han Lin, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/840,135

(22) Filed: May 6, 2004

(51) Int. Cl. G06F 15/16

(52) U.S. Cl. 709/219

(57) ABSTRACT

A method (500) of activating an application in a client/server environment can include the steps of selectively highlighting (502) an application on a user interface on a client device (10) wirelessly linked to a server (25, 26, or 27) and launching and activating the application and connecting (508) to the server upon selecting an input (37) (such as such as a PTT button) on the client device. The step of selectively highlighting can include the optional steps of scrolling (504) through a phonebook menu of options and selectively highlighting a connectivity identifier (506) among a plurality of connectivity identifiers. The client device can optionally connect to the server via a network associated with the connectivity identifier selectively highlighted (510). The method can further include the step of receiving (512) a response from the server in a form emulating a push-to-talk response.

### CROSS-REFERENCE TO RELATED APPLICATIONS

Not applicable

### FIELD OF THE INVENTION

This invention relates generally to user interfaces, and more particularly to a method and system for activating applications using a user interface on a communication device.

### BACKGROUND OF THE INVENTION

Push-to-talk (PTT) or Direct-Connect has proven to be an easy-to-use User Interface (UI) model for mobile communication products commonly found on products made by Motorola, Inc. of Schaumburg, Ill. A single button press can directly link a mobile subscriber user with another user for voice communications. Mobile handset application environments like J2ME (Java 2 Micro Edition) have opened up PDA-like applications for the mass, including many users that are not familiar with PC-style user interfaces. For this type of user, there fails to exist an optimized method of application launching and other interactions which would generally minimize the number of key presses required. Such interfaces have been so far limited to voice centric applications.

Currently, to utilize data services on a mobile communication unit, a complex number of keystrokes are typically required to obtain such services. Navigating through existing user interfaces can be complex and sometime counter-intuitive. No one has extended a simple PTT paradigm beyond voice applications in an era where data-centric or hybrid voce/data applications are becoming more and more prevalent.

### SUMMARY OF THE INVENTION

An end user can use a familiar phonebook UI and be relieved from the burden of navigating through a potentially complex UI in using a PTT style UI. The connection response and server feedbacks can be communicated PTT style as well.

In a first embodiment of the present invention, a method of activating an application in a client/server environment can include the steps of selectively highlighting the application among a plurality of applications on a user interface on a client device wirelessly linked to a server and launching and activating the application and connecting to the server upon pushing a button on the client device. The step of selectively highlighting can include the step of scrolling through a phonebook menu of applications. The method can further include the step of selectively highlighting a connectivity identifier among a plurality of connectivity identifiers and the step of connecting to the server can include the step of connecting to the server via a network associated with the connectivity identifier selectively highlighted. In one embodiment, the step of launching and activating and connecting can include the step of pushing a push-to-talk button on the client device. Additionally, the method can further include the step of receiving a response from the server in a form emulating a push-to-talk response.

In a second embodiment of the present invention, a communication device can include a transceiver communicatively coupled to at least one server, a user interface providing for a selection of at least one client/server application, an input device, and a processor coupled to the transceiver. The processor can be programmed to launch and activate the at least one client/server application and connect to the at least one server upon activating the input device. The user interface can further provide a selection of connectivity options to the at least one server and the selection of connectivity options can include a selection among at least one internet protocol address, at least one dispatch call address, and at least one phone number for example. Note, the device can be a JAVA enabled mobile handset such as a dispatch two-way radio or a multi-modal phone having at least a dispatch mode and the at least one client/server application can be a JAVA application. Furthermore, the user interface can include a display and a JAVA phonebook-like menu containing the selection of client/server applications and the input device can be a push-to-talk button.

In a third embodiment of the present invention, a communication system in a client/server environment can include at least one server and a communication device. The communication device can include a transceiver communicatively coupled to the at least one server, a user interface providing for a selection of at least one client/server application, an input device, and a processor coupled to the transceiver. The processor can be programmed to launch and activate the at least one client/server application and connect to the at least one server upon activating the input device.

In a fourth embodiment of the present invention, a computer program can include a plurality of code sections executable by a machine for causing the machine to perform the steps in the embodiments of the method, the communication device and the communication system described above.

### BRIEF DESCRIPTION OF THE DRAWINGS

FIG. 1 is a block diagram of a communication device and system using a user interface enabling a push to activate and connect (PAC) in accordance with an embodiment of the present invention.

FIG. 2 is a block diagram of a JAVA application that can use PAC in various communication modes in accordance with an embodiment of the present invention.

FIG. 3 illustrates a user interface having a phonebook-like entry in accordance with an embodiment of the present invention.

FIG. 4 illustrates another user interface having a phonebook-like menu for selection of applications in accordance with an embodiment of the present invention.

FIG. 5 is a flow chart illustrating a method of activating an application in a client/server environment in accordance with an embodiment of the present invention.

### DETAILED DESCRIPTION OF THE DRAWINGS

While the specification concludes with claims defining the features of the invention that are regarded as novel, it is believed that the invention will be better understood from a consideration of the following description in conjunction with the figures, in which like reference numerals are carried forward.

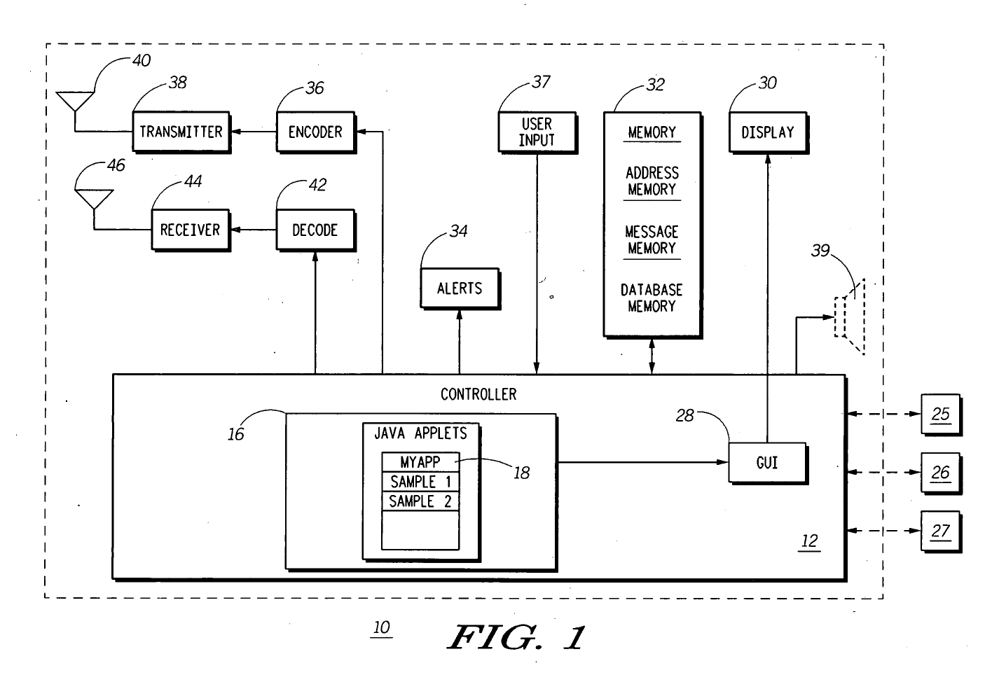

Referring to FIG. 1, a block diagram of a portable communication device 10 can comprise a conventional cellular phone, a two-way trunked radio, a combination cellular phone and personal digital assistant, a smart phone, a home cordless phone, a satellite phone or even a wired phone having a display and an ability to use a user interface in accordance with embodiments of the present invention. In this particular embodiment, the portable communication device 10 can include an encoder 36, transmitter 38 and antenna 40 for encoding and transmitting information as well as an antenna 46, receiver 44 and decoder 42 for receiving and decoding information sent to the portable communication device 10. The device 10 can further include an alert 34, memory 32, a user input device 37 (such as a keyboard, mouse, voice recognition program, etc.), a speaker or annunciator 39, and a display 30 for at least displaying a graphical user interface (GUI) 28 as will be further detailed below. The device 10 can further include a processor or controller 12 coupled to the display 30, the encoder 36, the decoder 42, the alert 34, the user input 37 and the memory 32. The memory 32 can include address memory, message memory, and memory for database information or for applications such as JAVA applications and the various modes of communication associated with such applications. Such applications can reside in external memory (32) or in internal memory 16 within a portion 14 of the processor 12 as shown. The memory (either 32 or 16) can include a database or one or more look-up tables that can correlate a selected portion of content from the GUI 28 with one or more applications. The communication device 10 can communicate, connect and otherwise retrieve or download (or upload) information from one or more remote servers 25, 26, and 27. If an Applet or J2ME MIDlet is used, then the new information can be retrieved from the address provided such as http://www.myApp.com/newApplication/. In an exemplary embodiment, the application used as the means for retrieving location information can be a Java-based application although other applications are contemplated within the scope of the present invention.

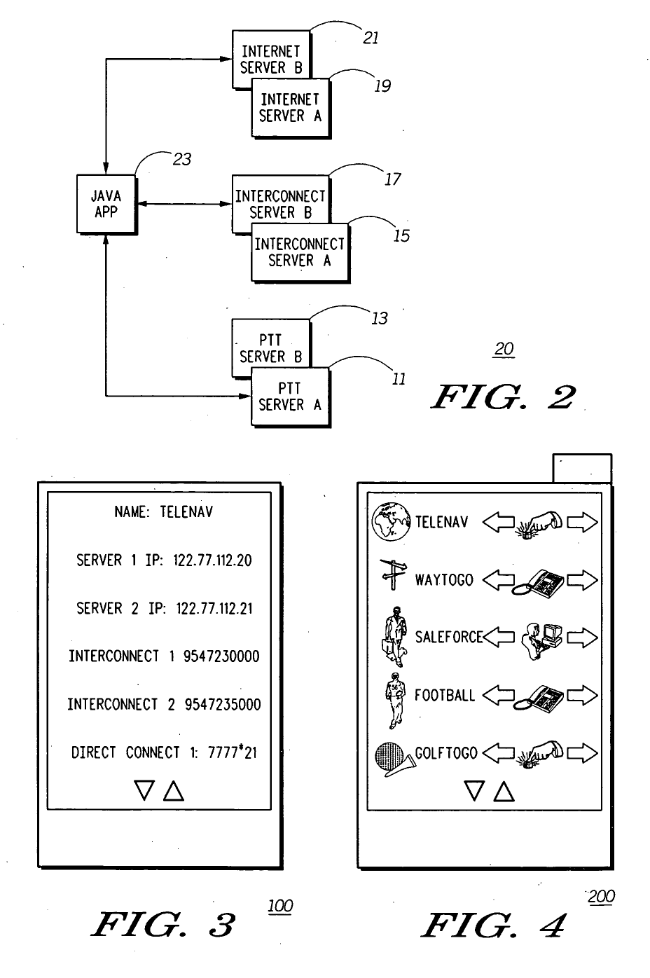

Java enabled mobile handsets can contain many type of Java applications, including the ones that connect with specialized servers like a navigation system. As shown in the system 20 of FIG. 2, a JAVA application 23 can have multiple modes of communication. For example, such application can connect with an internet server via an any number of IP addresses corresponding to addresses on servers 19 or 21 or with a voice-enabled server such as servers 15 or 17 via a interconnect number or connect with a voice-enabled server such as servers 11 or 13 via a direct-connect (dispatch or PTT) number. These servers are addressable using IP addresses or even phone (or interconnect) or dispatch (or direct-connect) numbers as illustrated in the phonebook-like user interface 100 shown in FIG. 3. These addresses are usually provisioned during application installation and downloading. In cases where multiple servers are available, the user may be required to select one of the servers available. Again, each application can have a phonebook-like entry, with the ability to provide multiple server IP addresses, interconnect numbers, and/or dispatch (PTT or private call ID or direct-connect) numbers. Also note that the servers described above can come in the form of a mobile device which would facilitate peer-to-peer communications and applications.

Each client/server Java application can be viewed as an entity that can be reached, which can have multiple fields with IP addresses and phone numbers. Referring once again to FIG. 3 and to FIG. 4, the usage model can be similar to the use of a phonebook. For example, the user can scroll through the Java menu like phonebook to select an application among a plurality of applications as illustrate in the phonebook-like user interface 200 of FIG. 4. When an application is highlighted, the user can see multiple choices (if any) indicated at the end of the entry. Each choice can be indicated by a distinct icon (for IP address, direct connect number, or phone number). The user can then push-to-activate-and-connect (PAC) the application by pushing a user input device such as a PTT button. Of course, other input devices or means such as voice activation can provide the same functionality. In response to the input, the application can be automatically launched and a connection to the server is obtained immediately. The server can respond by text or voice response system and can emulate PTT-like call backs. There is no limitation as to the applications that can be selected or used herein. Some examples include phonebooks, location finding, spreadsheets, sport statistics, ticket purchasing, or personal financial transactions or banking.

The end user can use the familiar phonebook UI and be relieved from the burden of navigating a potentially complex UI. The connection response and server feedbacks can be communicated PTT style as well.

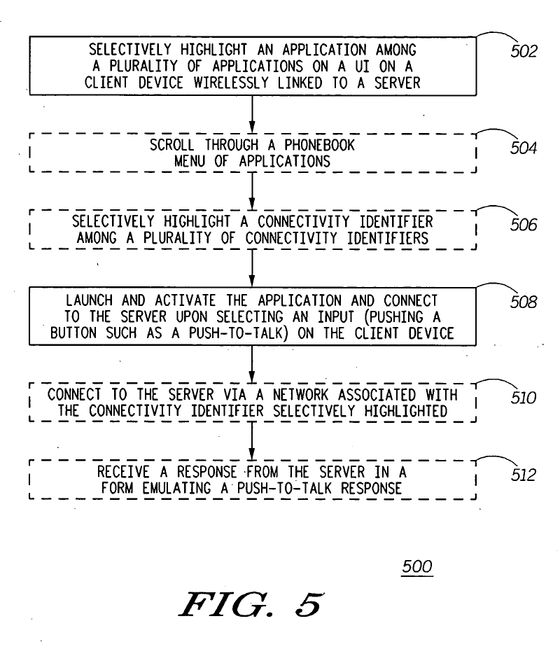

Referring to FIG. 5, a flow chart illustrating a method 500 of activating an application in a client/server environment can include the step 502 of selectively highlighting an application among a plurality of applications on a user interface on a client device wirelessly linked to a server and launching and activating the application and connecting to the server upon selecting an input (such as pushing a button such as a PTT button) on the client device at step 508. The step of selectively highlighting can include the optional step 504 of scrolling through a phonebook menu of options. The method can also include the optional step 506 of selectively highlighting a connectivity identifier among a plurality of connectivity identifiers. At step 510 the client device can optionally connect to the server via a network associated with the connectivity identifier selectively highlighted. The method 500 can further include the step 512 of receiving a response from the server in a form emulating a push-to-talk response.

In light of the foregoing description, it should be recognized that embodiments in accordance with the present invention can be realized in hardware, software, or a combination of hardware and software. A communications system or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

What is claimed is:

1. A method of activating an application in a client/server environment, comprising the steps of:
selectively highlighting the application among a plurality of applications on a user interface on a client device wirelessly linked to a server; and
launching and activating the application and connecting to the server upon pushing a button on the client device.

2. The method of claim 1, wherein the step of selectively highlighting comprises the step of scrolling through a phonebook menu of applications.

3. The method of claim 1, wherein the method further comprises the step of selectively highlighting a connectivity identifier among a plurality of connectivity identifiers.

4. The method of claim 3, wherein the step of connecting to the server comprises the step of connecting to the server via a network associated with the connectivity identifier selectively highlighted.

5. The method of claim 1, wherein the step of launching and activating and connecting comprises the step of pushing a push-to-talk button on the client device.

6. The method of claim 1, wherein the method further comprises the step of receiving a response from the server in a form emulating a push-to-talk response.

7. A communication device, comprising:
a transceiver communicatively coupled to at least one server;
a user interface providing for a selection of at least one client/server application;
an input device; and
a processor coupled to the transceiver, wherein the processor is programmed to launch and activate the at least one client/server application and connect to the at least one server upon activating the input device.

8. The communication device of claim 7, wherein the user interface further provides a selection of connectivity options to the at least one server.

9. The communication device of claim 8, wherein the selection of connectivity options comprises a selection among at least one internet protocol address, at least one dispatch call address, and at least one phone number.

10. The communication device of claim 7, wherein the communication device is a JAVA enabled mobile handset.

11. The communication device of claim 10, wherein the at least one client/server application is a JAVA application.

12. The communication device of claim 7, wherein the user interface comprises a JAVA phonebook-like menu containing the selection for the at least one client/server application.

13. The communication device of claim 7, wherein the communication device further comprises a display.

14. The communication device of claim 7, wherein the input device is a push-to-talk button.

15. The communication device of claim 7, wherein the communication device is selected among a group of devices comprising a dispatch two-way radio and a multi-modal phone having at least a dispatch mode.

16. A communication system in a client/server environment, comprising:
at least one server; and
a communication device, comprising:
a transceiver communicatively coupled to the at least one server;
a user interface providing for a selection of at least one client/server application;
an input device; and
a processor coupled to the transceiver, wherein the processor is programmed to launch and activate the at least one client/server application and connect to the at least one server upon activating the input device.

17. The communication system of claim 16, wherein the at least one server is a mobile communication device.

18. A machine readable storage, having stored thereon a computer program having a plurality of code sections executable by a machine for causing the machine to perform the steps of:
enable a user to selectively highlight an application in a client/server environment among a plurality of applications on a user interface on a client device wirelessly linked to a server; and
launch and activate the application and connect to the server upon pushing a button on the client device.

19. The machine readable storage of claim 18, wherein the computer program further has a plurality of code sections executable by the machine for causing the machine to perform the step of enabling a user to selectively highlight a connectivity identifier among a plurality of connectivity identifiers.

20. The machine readable storage of claim 18, wherein the computer program further has a plurality of code sections executable by the machine for causing the machine to perform the steps of launching, activating, and connecting upon detecting a push of a push-to-talk button on the client device.

21. The machine readable storage of claim 18, wherein the computer program further has a plurality of code sections executable by the machine for causing the machine to perform the step of receiving a response from the server in a form emulating a push-to-talk response.
